(19) United States
(12) Patent Application Publication
(10) Pub. No.: US 2025/0078172 A1
(43) Pub. Date: Mar. 6, 2025

(54) An Online Matchmaking System And Method Thereof Based On User's Phone Numbers

(71) Applicant: Marin Dujmic, Icici (HR)

(72) Inventor: Marin Dujmic, Icici (HR)

(21) Appl. No.: 18/240,094

(22) Filed: Aug. 30, 2023

(51) Int. Cl. G06Q 50/00; H04L 51/52

(52) U.S. Cl. CPC G06Q 50/01; H04L 51/52

(57) ABSTRACT

Disclosed herein is computer-implemented method and an online matchmaking system includes a graphical user interface operable to receive a plurality of user registration details including a phone number linked with a user profile, store information relating to each registered user in a database and provide a graphical representation on the graphical user interface of an electronic device. The graphical user interface including a search module for filling in a phone number. The graphical user interface is also operable to determine the matches between the first user and the second user after electronically receiving the request for matching from the first user and the second user by taking into account the expressed interest by inserting the phone number in the search module corresponding to first and second user respectively. The graphical user interface is also operable to confirm receipt of submission and send a message upon the match between the first user and the second user.

### FIELD OF DISCLOSURE

The present disclosure generally relates to dating and matchmaking services, more specifically relates to an online matchmaking system and method that may be substantially implemented via social media or a dating software.

### BACKGROUND OF THE DISCLOSURE

Nowadays, people use online dating platforms more frequently because they are more convenient than traditional dating methods (they can connect with potential partners from the comfort of their own home), and because they can be less intimidating for some people.

People who are too shy or nervous to approach the other person directly may be drawn to the idea of dating someone they met in their daily lives. Many online dating services are available in a market which provides a pool of potential matches to dating community. The existing online dating services use sophisticated matching algorithms to find compatible matches for from a group of unknown people based on the characteristics associated with each user.

However, the currently available online dating services do not offer any means for users to approach/date acquaintances or friends! Therefore, there is a perceived need to offer a mobile-based dating system or a technique that addresses the aforementioned issues. For example, we have all had the experience of meeting someone at a particular time (for example, at school, university, the workplace, etc.) with whom we felt some “chemistry” or, to put it another way, “felt immediately in love on first sight,” but we were too shy (or introverted) to express our feelings to each other.

Most of the time, users even have the mobile numbers of the people they are interested in dating, but they never even communicate because they are unsure of whether the other person likes them. Therefore, if nobody moves, nothing will happen, and in reality, nothing happens most of the time, and nobody ever knows if there was actually an attraction with the person we met or knew personally! The only realistic chance for these individuals to meet is if one of them expresses an explicit interest in the other, usually by actively engaging them in conversation. But if the other person (for a date) does not feel the same way or have the same interest, there is always the chance of public rejection.

There are numerous online dating services available in a market that offers the dating community a pool of potential matches. On the basis of the traits connected to each user, the current online dating services use sophisticated matching algorithms to identify compatible matches from a group of unknown individuals.

However, the currently available online dating services do not offer a way for users to look for, assess, and express interest in dating people they have met in the course of their daily lives. People may have an intense connection with someone, but for a variety of reasons, including a fear of being rejected, they may be hesitant or intimidated to express their love or reciprocal feelings through conventional communication channels or face-to-face interactions.

This technique offers a feature that is currently unavailable for conventional online dating and previous arts and is simple to implement in all existing social media or dating software. This is based on the likelihood that a couple will decide to exchange their mobile numbers in person before determining whether they are compatible for traditional dating through a match on a digital platform.

Therefore, there is a need in the field of technology for a new and improved user matching system and method that enables users to manually search for and decide on potential matches with other users whom they actually meet. Thus, all the advantages of using an online dating platform are maintained for the users while avoiding the need for complicated computer-based matching algorithms (such as convenience, decreased social pressure, time efficiency, privacy, and control, etc.).

A new system and approach that are intended to improve online matching services and that address the aforementioned issues are, therefore, recognised to be necessary.

### SUMMARY OF THE DISCLOSURE

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

According to illustrative embodiments, the present disclosure focuses on an online matchmaking system and method. Embodiments of the present invention address deficiencies of the art in respect of social networking and online dating and provide a novel and non-obvious method, in which a plurality of users can match each other based on their manual queries/inputs of the mobile number of the user with whom they would like to be match. So, the claimed invention and the features recited in the claims are directed to an improved user profile matching system.

The online matching system and method enables users to look through their own network of friends and acquaintances to identify potential dating partners.

The present invention provides the distinct advantage of incorporating “the human element” in a matchmaking system and method that is neither taught nor suggested in the related prior art. There does not exist a system which incorporates the human-based matchmaking method utilizing the user mobile phone numbers to receive, search and determine the potential matches among a plurality of users.

In light of the above, in one aspect of the present disclosure, a computer-implemented method for online matchmaking using one or more non-transitory computer-readable storage media, having computer-executable instructions embodied thereon. The computer-implemented method includes receiving a plurality of user registration details including a phone number linked with a user profile. The computer-implemented method also includes storing information relating to each registered user in a database along with the phone number. The computer-implemented method also includes providing a graphical representation on the graphical user interface of an electronic device. The computer-implemented method also includes prompting a first user to initiate a request for match with a second user by filling in the phone number corresponding to the second user in the search module of the graphical user interface. The computer-implemented method also includes determining the matches between the first user and the second user after electronically receiving the request for matching from the first user and the second user by taking into account the expressed interest by inserting the phone number in the search module corresponding to first and second user respectively. The computer-implemented method also includes displaying a graphical representation on the graphical user interface to confirm receipt of submission. The computer-implemented method also includes sending a message upon the match between the first user and the second user.

In one embodiment, the search module is configured to send search information to the database.

In one embodiment, the match is determined between the first user and second user based on a first user input in the search module of the phone number registered to the second user and a second user input in the search module of the phone number registered to the first user.

In one embodiment, the search module comprises a text area for filling of the phone number to be searched for the match between the first user and the second user, and a submit button.

In one embodiment, the message being sent to the first user and the second user about a positive match upon match being successful.

In one embodiment, the first user input and the second user input being transmitted via communication channels.

In one embodiment, the communication channels comprise a communication network including a data network such as, but not limited to, an Internet, a Local Area Network (LAN), a Wide Area Network (WAN), a Metropolitan Area Network (MAN), and a combination thereof.

In light of the above, in another aspect of the present disclosure, a non-transitory computer-readable storage media, having computer-executable instructions embodied thereon, wherein when executed by at least one processor, the computer-executable instructions cause the processor to receive a plurality of user registration details including a phone number linked with a user profile. The computer-executable instructions cause the processor to store information relating to each registered user in a database along with the phone number. The computer-executable instructions cause the processor to provide a graphical representation on the graphical user interface of an electronic device. The graphical user interface including a search module to prompt a first user from the plurality of users to initiate a request for match with a second user from the plurality of users by filling in the phone number corresponding to the second user in the search module. The computer-executable instructions cause the processor to determine the matches between the first user and the second user after electronically receiving the request for matching from the first user and the second user by taking into account the expressed interest by inserting the phone number in the search module corresponding to first and second user respectively. The computer-executable instructions cause the processor to display a graphical representation on the graphical user interface to confirm receipt of submission. The computer-executable instructions cause the processor to send a message upon the match between the first user and the second user.

In light of the above, in yet another aspect of the present disclosure, an online matchmaking system is disclosed herein. The online matchmaking includes graphical user interface operable to receive a plurality of user registration details including a phone number linked with a user profile. The graphical user interface is also operable to store information relating to each registered user in a database along with the phone number. The graphical user interface is also operable to provide a graphical representation on the graphical user interface of an electronic device. The graphical user interface including a search module to prompt a first user from the plurality of users to initiate a request for match with a second user from the plurality of users by filling in the phone number corresponding to the second user in the search module. The graphical user interface is also operable to determine the matches between the first user and the second user after electronically receiving the request for matching from the first user and the second user by taking into account the expressed interest by inserting the phone number in the search module corresponding to first and second user respectively. The graphical user interface is also operable to display a graphical representation on the graphical user interface to confirm receipt of submission. The graphical user interface is also operable to send a message upon the match between the first user and the second user.

In one embodiment, the search module is configured to send search information to the database.

In one embodiment, the match is determined between the first user and second user based on a first user input in the search module of the phone number registered to the second user and a second user input in the search module of the phone number registered to the first user.

In one embodiment, the search module comprises a text area for filling of the phone number to be searched for the match between the first user and the second user, and a submit button.

In one embodiment, the message being sent to the first user and the second user about a positive match upon match being successful.

In one embodiment, the first user input and the second user input being transmitted via communication channels.

In one embodiment, the communication channels comprise a communication network including a data network such as, but not limited to, an Internet, a Local Area Network (LAN), a Wide Area Network (WAN), a Metropolitan Area Network (MAN), and a combination thereof.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

These elements, together with the other aspects of the present disclosure and various features are pointed out with particularity in the claims annexed hereto and form a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure.

The advantages and features of the present disclosure will become better understood with reference to the following detailed description taken in conjunction with the accompanying drawing, in which:

FIG. 1 illustrates a block diagram of the online matchmaking system, in accordance with an exemplary embodiment of the present disclosure;

FIG. 2A to FIG. 2C illustrates successive stages of the online matchmaking system on an electronic device, in accordance with an exemplary embodiment of the present disclosure; and

FIG. 3 illustrates a flowchart of a computer-implemented method for online matchmaking, in accordance with an exemplary embodiment of the present disclosure.

Like reference, numerals refer to like parts throughout the description of several views of the drawing.

The online matchmaking system is illustrated in the accompanying drawings, which like reference letters indicate corresponding parts in the various figures. It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE DISCLOSURE

The following is a detailed description of embodiments of the disclosure depicted in the accompanying drawings. The embodiments are in such detail as to communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of the embodiments of the present disclosure. It may be apparent to one skilled in the art that embodiments of the present disclosure may be practiced without some of these specific details.

Various terms as used herein are shown below. To the extent a term is used, it should be given the broadest definition persons in the pertinent art have given that term as reflected in printed publications and issued patents at the time of filing.

The terms “a” and “an” herein do not denote a limitation of quantity, but rather denote the presence of at least one of the referenced items.

The terms “having”, “comprising”, “including”, and variations thereof signify the presence of a component.

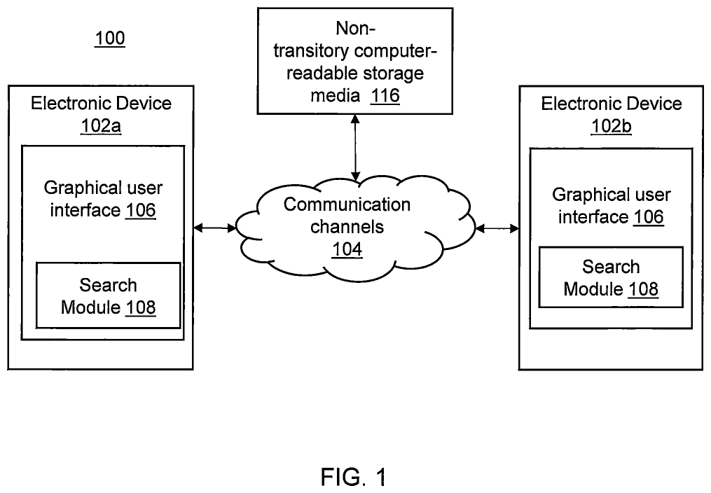

Referring now to FIG. 1 to FIG. 3 to describe various exemplary embodiments of the present disclosure. FIG. 1 illustrates a block diagram of the online matchmaking system 100, in accordance with an exemplary embodiment of the present disclosure. The online matchmaking system 100 may include a plurality of electronic devices 102a, 102b, and communication channels 104. A graphical user interface 106 may be associated with the electronic device 102a, 102b. Further, the graphical user interface 106 may comprise a search module 108 where the first user and the second user may input data which may be a phone number.

The online matchmaking system 100 may include the graphical user interface 106 operable to receive a plurality of user registration details including a phone number linked with a user profile. The online matchmaking system 100 may be designed to comprise the graphical user interface 106 for a specific group of people that may be a first user and a second user who are socializing, because they have a similar interest.

According to embodiments of the present invention, the first user and the second user may be configured to communicate with each other by one or more communication channels 104 via the electronic device 102a, 102b.

The communication channels 104 may comprise a communication network that may include a data network such as, but not limited to, an Internet, a Local Area Network (LAN), a Wide Area Network (WAN), a Metropolitan Area Network (MAN), and so forth. In some embodiments of the present invention, the communication channels 104 may include a wireless network, such as, but not limited to, a cellular network and may employ various technologies including an Enhanced Data Rates for Global Evolution (EDGE), a General Packet Radio Service (GPRS), and so forth. In some embodiments of the present invention, the communication channels 104 may include or otherwise cover networks or sub-networks, each of which may include, for example, a wired or a wireless data pathway.

Further, the communication channels 104 may include, but are not limited to, a coaxial cable, a copper wire, a fiber optic, a wire that comprise a system bus coupled to a processor of a computing device, and so forth. Embodiments of the present invention are intended to include or otherwise cover any type of the communication mediums, including known, related art, and/or later developed technologies.

According to an embodiment of the present invention, the electronic device 102a, 102b may be configured to enable a user to receive data and transmit data within the online matchmaking system 100. According to embodiments of the present invention, the electronic device 102a, 102b may be, but not limited to, a mobile device, a smart phone, a tablet computer, a portable computer, a laptop computer, a desktop computer, a smart device, a smart watch, a smart glass, and so forth. Embodiments are intended to include or otherwise cover any type of the electronic device 102a, 102b, including known, related art, and/or later developed technologies.

The graphical user interface 106 may be configured to enable the first user and the second user to input data in the search module 108, according to an embodiment of the present invention. The graphical user interface 106 may be further configured to display output data associated with the online matchmaking system 100, in an embodiment of the present invention.

The graphical user interface 106 may allow the first user and the second user to socially meet, interact, drop voicemails, messages, calls, based on the mutual interest.

The graphical user interface 106 may also operable to store information relating to each registered user in a database along with the phone number.

The graphical user interface 106 may also operable to provide a graphical representation on the graphical user interface 106 of the electronic device 102a, 102b. The graphical user interface 106 including the search module 108 may be configured to prompt a first user from the plurality of users to initiate a request for match with a second user from the plurality of users by filling in the phone number corresponding to the second user in the search module 108. The search module 108 may be configured to send search information to the database.

The search module 108 may comprise a text area for filling of the phone number to be searched for the match between the first user and the second user, and a submit button.

The graphical user interface 106 may be also operable to determine the matches between the first user and the second user after electronically receiving the request for matching from the first user and the second user by taking into account the expressed interest by inserting the phone number in the search module corresponding to first and second user respectively. In one embodiment, the match may be determined between the first user and second user based on a first user input in the search module 108 of the phone number registered to the second user and a second user input in the search module 108 of the phone number registered to the first user.

In one embodiment, the first user input and the second user input being transmitted via communication channels 104.

In one embodiment, the communication channels 104 may comprise the communication network including a data network such as, but not limited to, an Internet, a Local Area Network (LAN), a Wide Area Network (WAN), a Metropolitan Area Network (MAN), and so forth.

The graphical user interface 106 is also operable to display a graphical representation on the graphical user interface 106 to confirm receipt of submission.

The graphical user interface 106 may also be operable to send a message upon the match between the first user and the second user. Moreover, the message may be sent to the first user and the second user about a positive match upon match being successful. In one embodiment, the message may be a SMS message sent on the electronic device 102a, 102b of matched users.

Consider in a simplistic example, a scenario where a first user (“John”) meets “Ann”, another fictitious user, at work. They both felt a strong connection whilst they were introduced to each other and whilst they exchanged their phone numbers. John wants to call Ann for a date; however, he feels intimidated to approach Ann directly or through standard communication channels. Instead, he uses the online matchmaking system 100 and method 300 to express and determine his potential match with Ann, before doing his first move. Ann is also interested to date John, and she also uses the same online matchmaking system 100 and method 300 to express and determine her potential match with John, knowing that the whole process is initially anonymous and that her interest in John will only be disclosed if both users prompt the online matchmaking system 100 and method 300 for them to be matched.

The advantage being, among others, that John and Ann would be subsequently informed preferably by SMS text message about their match so that they may proceed with conventional dating, thus saving each other time, energy and potential heartbreak.

In one embodiment of the present invention, John initiates the request for matching by providing Ann's mobile phone number, and Ann initiates the request to be match with John's mobile number, indicating her interest in going on a date with John. This is an example of a match.

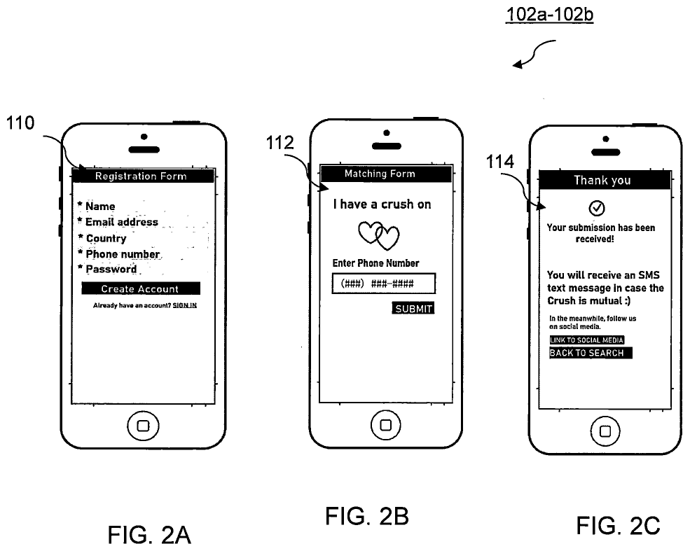

FIG. 2A to FIG. 2C illustrates successive stages of the online matchmaking system 100 on the electronic device, according to embodiments of the present invention. In one embodiment, the graphical user interface 106 presents a registration form 110 to the first user and the second user. The registration form 110 includes a text area for filling name, email address, country, phone number, password, and so forth. The registration form 110 may comprise a create account button. Further, the registration form 110 may comprise a sign in link if any of the first user or the second user registering on the electronic device 102a, 102b already have an account. The graphical user interface 106 presents a matching form 112 and the search module 108 to the first user and the second user where both the first user may fill the phone number of the second user on which the first user's interest is expressed, as seen in FIG. 2B.

Further, the second user may fill the phone number of the first user on which the second user share interest. The matching form 112 details are further submitted to a matching server which on receival displays a message on the graphical user interface that the submission is received 114 and a message may be received in case the interest is mutual whilst preserving, at the same time, the anonymity of all the users involved until a mutual match is determined, as seen in FIG. 2C. Furthermore, the first user and the second user may follow on social media or may get back to new search on the search module 108.

A non-transitory computer-readable storage media 116, having computer-executable instructions embodied thereon, wherein when executed by at least one processor, the computer-executable instructions cause the processor to receive a plurality of user registration details including a phone number linked with a user profile. Further embodiments include a non-transitory computer-readable storage media 116 storing instructions that when executed by a computer system cause the computer system to perform the method set forth above, and a computer system programmed to carry out the method set forth above.

The computer-executable instructions cause the processor to store information relating to each registered user in a database along with the phone number. The computer-executable instructions cause the processor to provide a graphical representation on the graphical user interface of an electronic device 102a, 102b. The graphical user interface 106 may include the search module 108 to prompt a first user from the plurality of users to initiate a request for match with a second user from the plurality of users by filling in the phone number corresponding to the second user in the search module 108. The computer-executable instructions cause the processor to determine the matches between the first user and the second user after electronically receiving the request for matching from the first user and the second user by taking into account the expressed interest by inserting the phone number in the search module 108 corresponding to first and second user respectively. The computer-executable instructions cause the processor to display a graphical representation on the graphical user interface 106 to confirm receipt of submission. The computer-executable instructions cause the processor to send a message upon the match between the first user and the second user.

The present invention addresses the above-described needs in the art. In particular, in accordance with one aspect of the present invention, the online matchmaking system 100 also referred to as a profile matching system is customized to facilitate finding a companion among their immediate social circles. The online matchmaking system 100 and method 300 provide functionality for determining whether a first and second user are interested to initiate conventional dating. This invention overcoming shyness or social anxiety issues, for individuals who struggle with approaching others in person. The present invention provides a less intimidating platform for users to express their interest for a potential match with other users whose they've already met in person and this aspect is not yet addressed in prior art.

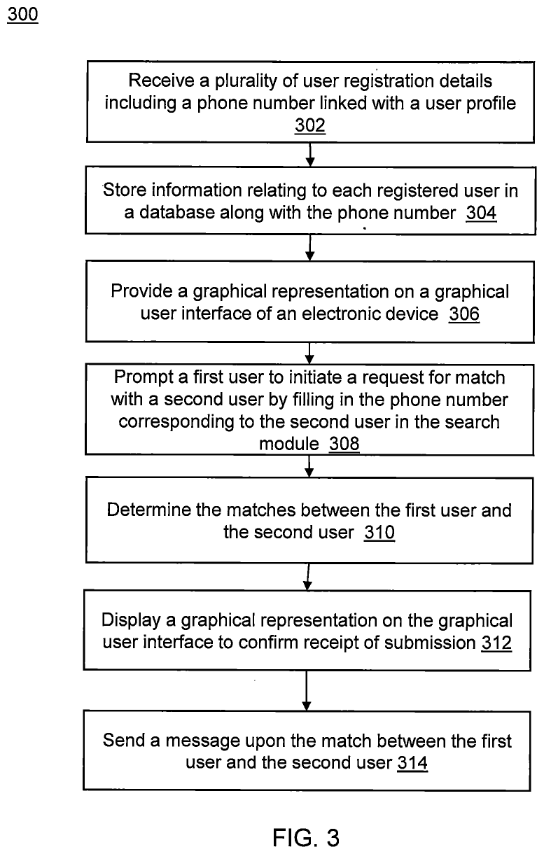

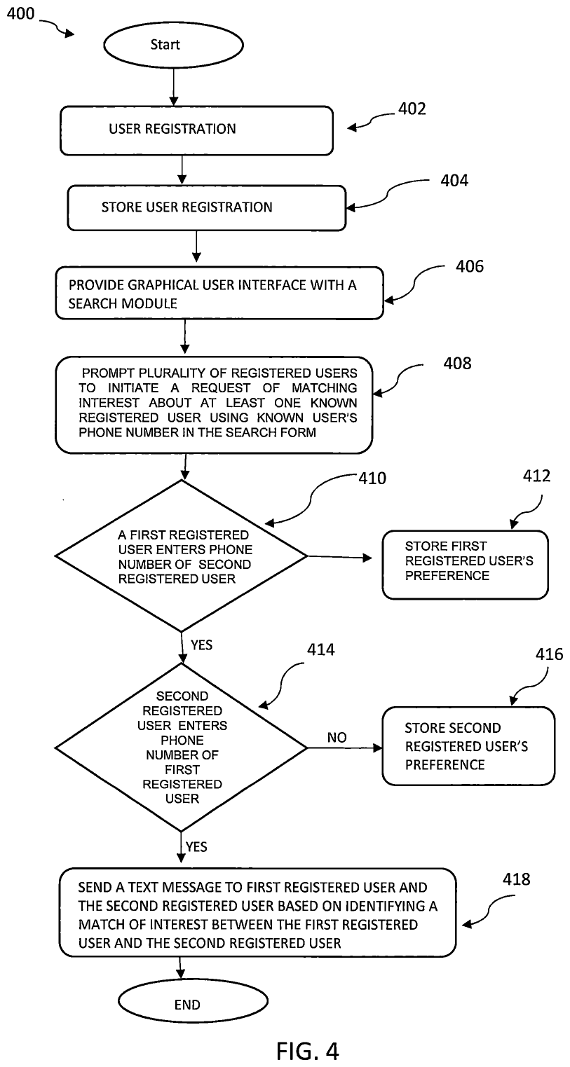

FIG. 3 illustrates a flowchart 300 of a computer-implemented method for online matchmaking, according to embodiments of the present invention. The computer-implemented method 300 for online matchmaking uses one or more non-transitory computer-readable storage media 116, having computer-executable instructions embodied thereon.

At 302, receiving a plurality of user registration details including a phone number linked with a user profile.

At 304, storing information relating to each registered user in a database along with the phone number.

At 306, providing a graphical representation on the graphical user interface 106 of the electronic device 102a, 102b.

At 308, prompting a first user to initiate a request for match with a second user by filling in the phone number corresponding to the second user in the search module of the graphical user interface 106.

At 310, determining the matches between the first user and the second user after electronically receiving the request for matching from the first user and the second user by taking into account the expressed interest by inserting the phone number in the search module 108 corresponding to first and second user respectively. Additionally, the search module 108 may comprise the text area for filling of the phone number to be searched for the match between the first user and the second user, and the submit button. Further, the search module 108 may be configured to send search information to the database.

At 312, displaying a graphical representation on the graphical user interface 106 to confirm receipt of submission.

At 314, sending a message upon the match between the first user and the second user. Further, the message being sent to the first user and the second user about a positive match upon match being successful. The match is determined between the first user and second user based on a first user input in the search module 108 of the phone number registered to the second user and a second user input in the search module 108 of the phone number registered to the first user.

According to an embodiment of the present invention, a process for user profile matching may include establishing an electronic connection between two users, prompting the first user to indicate whether they had interest in a second user, determining a two-way match if both first and second user indicate an interest in each other, apprising the users whether a two-way match has occurred and invite the users to continue the communication through standard communication channels.

Embodiments of the present invention provide a novel and non-obvious method by which a plurality of users can match each other based on their manual queries/inputs of the mobile number of the user with whom they would like to be matched, addressing deficiencies of the art in relation to social networking and online dating. Consequently, an improved user profile matching system is the subject of the claimed invention and the features listed in the claims.

Applicant's method provides distinct advantages over the prior art. For example, while computer algorithms for matchmaking (such as in the prior art) are becoming more and more advanced, the “human element” factor is still missing. Using Applicant's methods, online matchmaking is propelled beyond dispassionate database comparisons into a realm where human intuition is extolled as a primary variable in a matchmaking method.

While some of the prior art may teach some solutions to several of these problems, the core issue of matching users based on the matching criteria that is based on mutual user queries/search over the mobile number of the other user, thus taking into account their express interest to be matched, is not addressed by prior art.

While the invention has been described in connection with what is presently considered to be the most practical and various embodiments, it will be understood that the invention is not to be limited to the disclosed embodiments, but on the contrary, is intended to cover various modifications and equivalent arrangements included within the scope of the appended claims.

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The embodiments were chosen and described to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the present disclosure.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims. cm What is claimed is:

1. A computer-implemented method for online matchmaking using at least one non-transitory computer-readable storage media, having computer-executable instructions embodied thereon and executed by at least one processor, the computer-implemented method configured to:
receive a plurality of user registration details for registering the plurality of users, each of the user registration details includes a phone number linked with a user profile on a graphical user interface of an electronic device of the user;
store information relating to each registered user in a database along with the phone number;
provide a graphical representation on the graphical user interface of the electronic device of each registered user;
prompt each of the plurality of registered user to initiate a request of matching of interest about at least one known registered user amongst the plurality of registered users;
wherein a first registered user initiates a request of matching interest for a second registered user by submitting the request of matching interest by inputting a phone number corresponding to the second registered user in a search module of the graphical user interface of the electronic device of the first registered user and the request of matching interest is stored as first registered user's preference;
wherein if the second registered user initiates a request of matching interest for a registered user other than the first registered user by submitting a request of matching interest by inputting a phone number corresponding to the registered user other than the first registered user in a search module of the graphical user interface of the electronic device of the second registered user, then the request of matching interest is stored as second user's preference;
wherein if the second registered user initiates the request of matching interest for the first registered user by submitting the request of matching interest by inputting the phone number corresponding to the first registered user in the search module of the graphical user interface of the electronic device of the second registered user, then based on identifying a match of interest between the first registered user and the second registered user, a text message of interest is sent to the first registered user and the second registered user;
wherein the first registered user and the second registered user are known to each other and both the first registered user and the second registered user remained anonymous until first registered user's preference and the second registered user's preference are matched based on identifying a match of interest between the first registered user and the second registered user.

2. The computer-implemented method of claim 1, wherein the search module is configured to send the request of matching interest with the phone number of the known registered user to the database.

3. (canceled)

4. The computer-implemented method of claim 1, wherein the inputs provided by the at least one known registered user and the at least one of the plurality of the registered user are transmitted via a communication channels to a storage media.

5. The computer-implemented method of claim 4, wherein the communication channels comprise a communication network including one or more of the Internet, a Local Area Network (LAN), a Wide Area Network (WAN), a Metropolitan Area Network (MAN).

6. The computer-implemented method of claim 1, wherein the search module comprises a text area for filling in of the phone number to be searched and a submit button.

7. The computer-implemented method of claim 1, wherein the text message is sent to at least one known registered user and the at least one of the plurality of registered user based on a successful positive match of interest for each other.

8. (canceled)

9. A computer-implemented online matchmaking system, the matchmaking system comprising:
a graphical user interface configured to receive a plurality of user registration details for registering the plurality of users, each of the user's registration details includes a phone number linked with a user profile on an electronic device of the user;
a database configured to store information of each registered user along with the phone number;
a matching form configured to show a graphical representation on the graphical user interface of the electronic device, the graphical user interface includes a search module configured to prompt the plurality of registered user to initiate a request of matching interest about at least one known registered user amongst the plurality of registered users;
wherein the matching form is configured to receive a request of matching interest from a first registered user about a second registered user by inputting a phone number corresponding user to the second registered user in the search module of the graphical user interface of the electronic device of the first registered user and the request of matching interest is stored as first registered user's preference;
a matching server configured to identify a match between the first registered user and the second registered user, and send a text message based on the identified match of interest between the first registered user and the second registered user, if;
the database of the system has an existing request of matching interest in the matching form from the second registered user about the first registered user by inputting a phone number corresponding to the first registered user in the search module of the graphical user interface of the electronic device of the second registered user and the request of matching interest is stored as second registered user's preference;
wherein the first registered user and the second registered user are known to each other and both the first registered user and the second registered user remained anonymous until first registered user's preference and the second registered user's preference are matched based on identifying a match of interest between the first registered user and the second registered user.

10. The online matchmaking system of claim 9, wherein the search module is configured to send the request of matching interest with the phone number of the known registered user to the database.

11. The online matchmaking system of claim 9, wherein the match is determined between the at least one known registered user by inputting the phone number corresponding to the at least one of the plurality of registered user through a input means in the search module of a graphical user interface of an electronic device of the at least one known registered user.

12. The online matchmaking system of claim 9, wherein the inputs provided by at least one known registered user and the at least one of the plurality of registered user are transmitted via a communication channels.

13. The online matchmaking system of claim 12, wherein the communication channels comprise a communication network including one or more of the Internet, a Local Area Network (LAN), a Wide Area Network (WAN), a Metropolitan Area Network (MAN).

14. The online matchmaking system of claim 9, wherein the search module comprises a text area for filling in of the phone number of the at least one known registered user and the at least one of the plurality of registered user.

15. The online matchmaking system of claim 9, wherein text message is sent to least one known registered user and the at least one of the plurality of registered user based on a successful positive match.

16. (canceled)
